(19) United States
(12) Patent Application Publication
(10) Pub. No.: US 2013/0131861 A1
(43) Pub. Date: May 23, 2013

(54) Media and Fuel Dispensing Apparatus and Method

(71) Applicant: Lakshmi Yechuri, Suwanee, GA (US)

(72) Inventor: Lakshmi Yechuri, Suwanee, GA (US)

(21) Appl. No.: 13/299,860

(22) Filed: Nov. 18, 2011

(51) Int. Cl. G06F 17/00

(52) U.S. Cl. 700/232

(57) ABSTRACT

A media and fuel dispensing apparatus and method whereby a customer can purchase fuel and also purchase or rent a copy of a digital versatile disc (“DVD”), compact disc (“CD”), or other similar media product. In various embodiments, the media and fuel dispensing apparatus comprises a touch screen device in which the customer can select a DVD or other media product for dispensing as well as purchase fuel.

### BACKGROUND OF THE INVENTION

Self service fuel pumping stations allow a customer to purchase fuel for his vehicle or other use. Such fuel pumping stations typically dispense gasoline or diesel; however, other fuels such as aviation fuel, boating fuel, or other fuels may be suitable for dispensing from such pumping stations. Such self service pumping stations typically allow the customer to pay for his purchase at the pumping station by inserting a credit card, debit card, or other method of payment into a payment device associated with the pumping station.

### SUMMARY OF THE INVENTION

Described herein is a media and fuel dispensing apparatus and method whereby a customer can purchase fuel and also purchase or rent a copy of a digital versatile disc (“DVD”), compact disc (“CD”), or other similar media product. In various embodiments, the media and fuel dispensing apparatus comprises a touch screen device in which the customer can select a DVD or other media product for dispensing. The apparatus preferably comprises an inventory of popular media products such that the customer may choose from a variety of titles. Once the customer selects a DVD title and payment is confirmed, the apparatus will dispense the DVD to the customer.

### BRIEF DESCRIPTION OF THE DRAWINGS

FIG. 1 shows a front view of a media and fuel dispensing apparatus in one embodiment of the invention.

FIG. 2 is a logical diagram of the major components of a media and fuel dispensing apparatus in one embodiment of the invention.

FIG. 3 is a flowchart of a method for dispensing fuel and renting or purchasing a media product in one embodiment of the invention.

### DETAILED DESCRIPTION

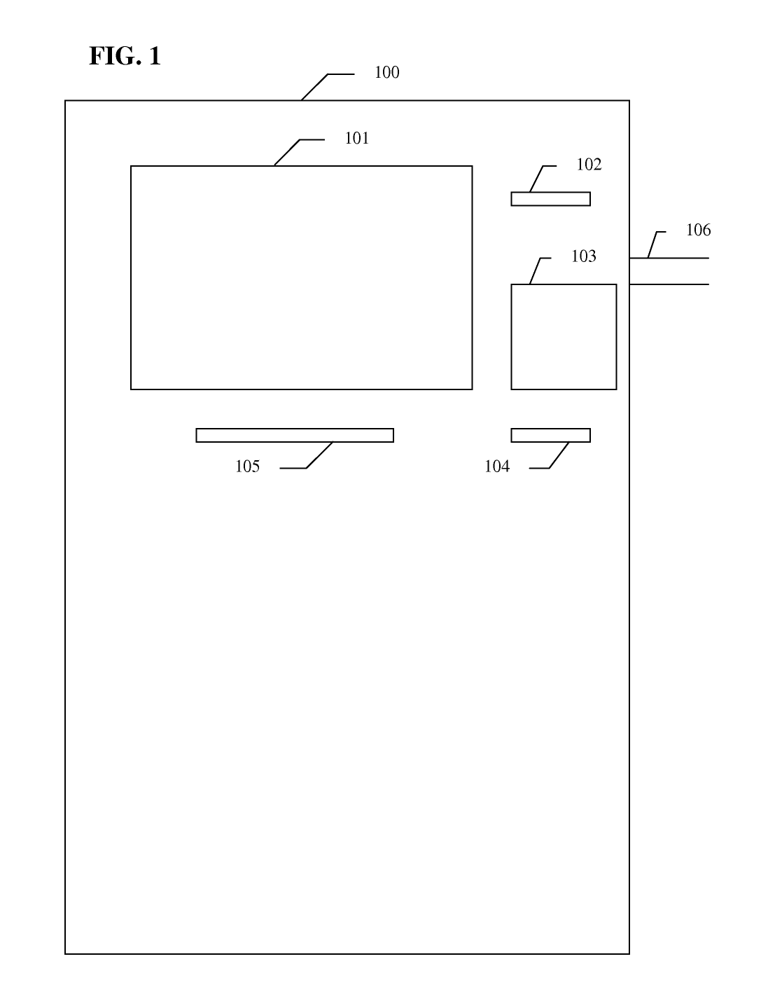

FIG. 1 shows a front view of a media and fuel dispensing apparatus 100 in one embodiment of the invention. The apparatus 100 preferably comprises a display 101 suitable for presenting instructions or other information to the customer. In some embodiments, the display 101 comprises a liquid crystal display (“LCD”). In some embodiments, the display 101 is a touch screen device capable of receiving user input from the customer. In some embodiments, an optional input device 103 (such as a PIN pad, keyboard, and/or menu device) is present.

Media and fuel dispensing apparatus 100 also comprises a fuel hose 106 for dispensing fuel to the customer. One end of fuel hose 106 is connected to the housing of the apparatus 100 and thence to a fuel tank (not pictured) which contains the fuel to be dispensed. The other end of fuel hose 106 is connected to a nozzle (not shown) suitable for dispensing fuel into the customer's vehicle or container.

Preferably, media and fuel dispensing apparatus 100 further comprises a card reader 102 suitable for receiving input from a credit card, debit card, or other type of payment card. In some embodiments, card reader 102 may comprise a magnetic card reader. In other embodiments, card reader 102 may comprise an NFC (near field communications) reader and/or an RFID (radio frequency identification) reader. In yet other embodiments, card reader 102 may comprise combinations of the foregoing. In some embodiments, the media and fuel dispensing apparatus 100 may comprise a currency acceptor for accepting bills or notes.

Media and fuel dispensing apparatus 100 further comprises a dispenser 105 suitable for dispensing a DVD or other media product. In some embodiments, the dispenser 105 may comprise a slot, said slot comprising mechanical actuators for pushing the DVD out of the dispenser 105. In other embodiments, the dispenser 105 may comprise a chute or similar device for dispensing media products.

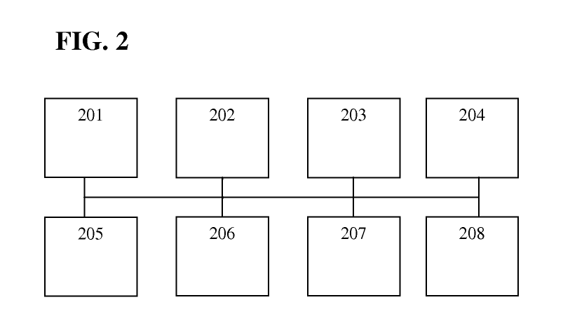

Internally, the media and fuel dispensing apparatus 100 comprises a DVD storage and dispensing system 206 (FIG. 2). Such systems may comprise a rack containing a plurality of shelves, each shelf containing a single DVD. Typically, each DVD is enclosed within a protective case so the DVD will not be damaged during handling by the apparatus 100. The DVD storage and dispensing system 206 may also comprise one or more motorized grippers (not shown) that are adapted to travel to the location of a selected DVD, grip the DVD, and transport the DVD to the dispenser 105. As known to those of skill in the art, such grippers may comprise wheels that enable the gripper to travel on one or more tracks. Such tracks may be oriented in three orthogonal directions (such as vertically, horizontally, and laterally) to enable the gripper to travel in all three dimensions within the apparatus 100.

Media and fuel dispensing apparatus 100 further preferably comprises a receipt printer/dispenser 104 for printing and dispensing paper receipts to the customer. Such printers are known to those of skill in the art and may comprise single sided or dual sided printing.

FIG. 2 shows a logical diagram of the major components of a media and fuel dispensing apparatus 100 in one embodiment of the invention. The media and fuel dispensing apparatus 100 comprises one or more processors 201 for controlling operation of the apparatus 100. Such processor 201 may comprise a general purpose processor or a specialized processor such as an application specific integrated circuit (ASIC). Apparatus 100 may also comprise a memory device 202 suitable for storing data. Such memory device 202 may comprise RAM, ROM, DRAM, SDRAM, flash memory, or the like. In addition, the media and fuel dispensing apparatus 100 optionally comprises a non-volatile data storage device 203. Said data storage device 203 may contain data such as cryptographic keys for encoding sensitive data.

The media and fuel dispensing apparatus 100 further preferably comprises an input/output (“I/O”) controller 205 suitable for operating display 101, card reader 102, and/or optional input device 103. The apparatus 100 also preferably comprises a communications subsystem 204 suitable for communication over a network connection 207 to a remote computer or remote network. As discussed in more detail below, such communications may allow for the authorization and processing of the customer's payment as well as the inventory management of the DVDs or other media products stored in the apparatus 100.

The media and fuel dispensing apparatus 100 also comprises a DVD dispensing subsystem 206. Such a subsystem 206 may comprise one or more grippers adapted to travel on tracks or rails as described above. Apparatus 100 also preferably comprises a fuel dispensing subsystem 208 adapted for pumping fuel from one or more storage tanks into the customer's vehicle via fuel hose 106. Such a fuel dispensing subsystem 208 may comprise one or more pumps for pumping fuel, as known to those with skill in the art.

As shown in FIG. 2, the various components of the media and fuel dispensing apparatus 100 are preferably connected to one another by way of a data communications bus. This bus allows the processor 201 to communicate with the other subsystems of the media and fuel dispensing apparatus 100. As will be apparent to those skilled in the art, a plurality of busses or other interconnections may be used in place of the single bus shown in FIG. 2.

In alternate embodiments, media and fuel dispensing apparatus 100 may be separated into two housings, the first housing comprising the fuel dispensing subsystem 208 and the second housing comprising the DVD storage and dispensing subsystem 206. In some such embodiments, the media and fuel dispensing apparatus may be operated by a single touch screen display 101 located in either housing. Specifically, in such embodiments, the customer can order fuel and order DVD(s) or other media item(s) using the single touch screen display 101. In some embodiments, the dual-housing media and fuel dispensing apparatus 100 may be operated by a single input device 103. In such embodiments, the customer can order fuel and DVD(s) using the single input device 103.

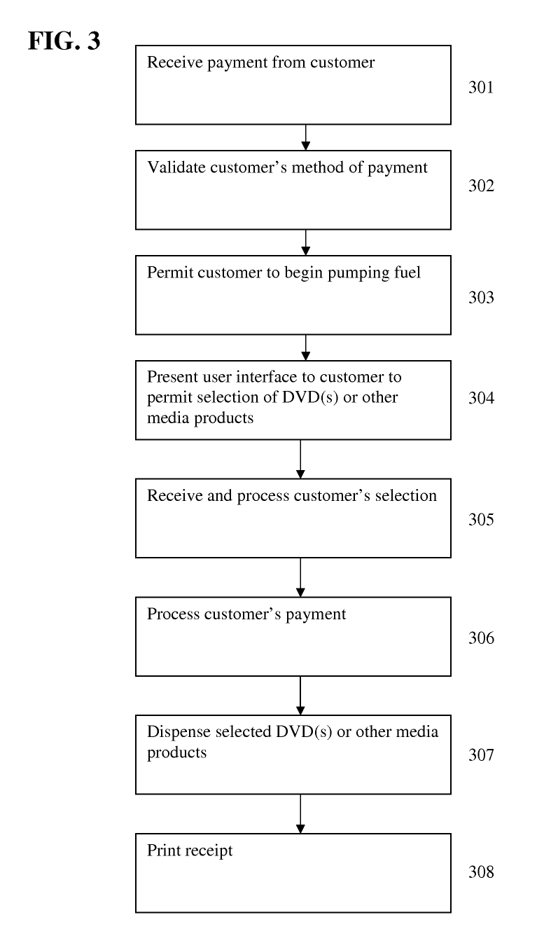

Turning to FIG. 3, a method for dispensing fuel and renting/purchasing a DVD from a media and fuel dispensing apparatus 100 is shown. At step 301, the customer inserts his credit card, debit card, or other payment card into card reader 102. In some embodiments, the media and fuel dispensing apparatus 100 may comprise an optional slot for receiving currency (including notes and/or coins). In some embodiments, the card reader 102 may comprise an NFC reader or an RFID reader. In some embodiments, the apparatus 100 may comprise an input device 103 adapted to receive a personal identification number (“PIN”) from the customer for use in validating the customer's debit card or credit card. In some embodiments, the customer may insert currency (notes and/or coins) into the apparatus 100 for payment.

At step 302, the apparatus 100 validates the customer's method of payment. If the method of payment is a credit card or debit card, the processor 201 of apparatus 100 will preferably utilize communication subsystem 204 to contact a remote server over network 207. The remote server (not shown) will authorize or deny the customer's method of payment based on the customer's credit limit, the amount of funds in the customer's bank account, or other criteria. If the customer's transaction is denied, then the apparatus 100 will not permit the customer to purchase fuel or a DVD.

If the customer's method of payment is approved, the method proceeds to step 303 where the processor 201 of apparatus 100 will send a signal to the fuel dispensing subsystem 208 to permit the customer to being pumping fuel.

At step 304, the display 101 of apparatus 100 will present a menu or other user interface to the customer for purchasing or renting a DVD or other media item. In some embodiments, the display 101 will present an advertisement to the customer encouraging him to rent a DVD. Such an advertisement may contain one or more clips of movies or other media products that are currently available in the apparatus's 100 inventory. In some embodiments, the apparatus 100 may comprise an optional audio speaker for playing sounds associated with said advertisement. In some embodiments, the display 101 will present a graphical user interface to the customer, allowing the customer to select DVDs for purchase or rental from the apparatus 100. As discussed above, the display 101 may comprise a touch screen device capable of receiving input from the customer. In some embodiments, an input device 103 may be used to select DVDs for purchase or rental.

At step 305, the apparatus 100 will receive and process a selection of one or more DVDs from the customer for purchase or rental. At step 306, the processor 201 of apparatus 100 will process the payment for the selected DVD(s). In some embodiments, the apparatus 100 will wait until the customer completes pumping fuel before processing the payment. In such embodiments, the apparatus 100 may process the payment for the fuel and the selected DVD(s) simultaneously. In some embodiments, the processor 201 of apparatus 100 will utilize communication subsystem 204 to contact a remote server over network 207 to finalize the payment.

At step 307, the processor 201 will send a signal to the DVD dispensing subsystem 206 to dispense the selected DVD(s). As described above, DVD dispensing subsystem 206 may comprise a rack of shelves, with each shelf containing a single DVD. The DVD dispensing subsystem 206 may further comprise a gripper adapted to travel along tracks or rails inside the apparatus 100 to retrieve DVDs and transport them to a dispenser 105. The customer can then retrieve the selected DVD(s) from the dispenser 105.

At step 308, the apparatus 100 may optionally print a receipt and dispense the receipt to the customer utilizing receipt printer/dispenser 104. Preferably, the receipt will contain an itemized bill of the customer's total purchase, including line items for the purchased fuel and the rented/purchased DVD(s). The receipt may also contain a due date for when the DVD(s) must be returned.

Those skilled in the art will understand that the steps shown in FIG. 3 do not need to be performed in the order presented and that variations in the order of the steps may be permitted.

Accordingly, while the invention has been described with reference to the structures and processes disclosed, it is not confined to the details set forth, but is intended to cover such modifications or changes as may fall within the scope of the following claims.

What is claimed is:

1. A method for dispensing fuel and a media item from an apparatus comprising a processor, a display, an input device, a card reader, a fuel pumping subsystem, and a media dispensing subsystem, the method comprising:
a) reading a customer's payment card at said card reader,
b) communicating, by said processor, with a remote server to validate said payment card,
c) receiving, by said processor, a validation signal from said remote server,
d) sending a signal from said processor to said fuel pumping subsystem to permit the pumping of fuel,
e) presenting a user interface to the customer utilizing said display,
f) receiving, by said processor, a selection of a media product from said customer,
g) communicating, by said processor, with a remote server to process a payment for said selection,
h) sending a signal from said processor to said media dispensing subsystem to dispense said selection, and
i) dispensing a media product corresponding to said selection.

2. The method of claim 1 further comprising the step of printing a receipt and dispensing said receipt to the customer.

3. The method of claim 1 wherein said media product is selected from the group consisting of: digital versatile disc or compact disc.

4. The method of claim 1 wherein said display comprises a touch screen display and wherein the selection of step (f) is performed utilizing said touch screen display.

5. The method of claim 1 wherein said apparatus comprises two housings, the first housing containing said fuel pumping subsystem, and the second housing containing said media dispensing subsystem.

6. The method of claim 5 wherein the apparatus comprises a single display.

7. A media and fuel dispensing apparatus comprising:
a processor;
a display;
an input device;
a card reader;
a fuel pumping subsystem, and
a media dispensing subsystem;
wherein the processor is adapted to:
a) receive a signal from said card reader containing information from a customer's payment card,
b) communicate with a remote server to validate said payment card,
c) send a signal to said fuel pumping subsystem to permit the pumping of fuel,
d) send one or more signals to said display to present a user interface to said customer,
e) receive a selection of a media product from said input device,
f) communicate with a remote server to process payment for said selection, and
g) send one or more signals to said media dispensing subsystem to dispense said selection.

8. The media and fuel dispensing apparatus of claim 7 wherein said media dispensing subsystem is adapted to dispense the selection in response to receiving the one or more signals of step (g).

9. The media and fuel dispensing apparatus of claim 8 wherein said processor is further adapted to send a signal to a receipt printer to print a receipt for said customer.

10. The media and fuel dispensing apparatus of claim 8 wherein said display comprises a touch screen display.

11. The media and fuel dispensing apparatus of claim 8 further comprising two housings, the first housing containing said fuel pumping subsystem, and the second housing containing said media dispensing subsystem.

12. The media and fuel dispensing apparatus of claim 11 wherein the apparatus comprises a single display.
